(19) United States
(12) Patent Application Publication
(10) Pub. No.: US 2003/0182996 A1
(43) Pub. Date: Oct. 2, 2003

(54) Tyre condition indicating apparatus

(76) Inventors: Adrian Edmund Bankart, London (GB); Sarah Catherine Bradshaw, London (GB)

Correspondence Address: LARSON & TAYLOR, PLC, 1199 NORTH FAIRFAX STREET, SUITE 900, ALEXANDRIA, VA, 22314, US

(21) Appl. No.: 10/344,635

(22) PCT Filed: Aug. 15, 2001
(86) PCT No.: PCT/GB01/03658

(30) Foreign Application Priority Data
Sep. 16, 2000 (GB) 0020226.7

(51) Int. Cl. G01M 17/02; E01C 23/00

(52) U.S. Cl. 73/146

(57) ABSTRACT

Tyre condition sensing apparatus carried by a vehicle has a relay module (4) in the vicinity of a vehicle wheel. The relay module (4) detects a tyre condition of a tyre in the vehicle such as tyre pressure. Tyre condition indicating apparatus carried by the vehicle has a display module (5) at the vehicle dashboard, and a sounder module (50) arranged in the vicinity of the wheel. The sounder module (50) gives audio indications audible at the wheel corresponding to visual or audio indications given at the dashboard by the display module (5). The indications are permanently off for a normal condition, permanently on for an above-normal condition and intermittently on for a below-normal condition.

The present invention relates to tyre condition indicating apparatus, and in particular but not exclusively to tyre pressure indicating apparatus.

With in-vehicle tyre condition sensing apparatus, the wheels and tyres rotate relative to the vehicle and sensed information has to be passed from the rotating wheel to the vehicle chassis. Wheels and tyres must still be interchangeable by users and garages and any failures must have safe consequences. Furthermore, tyre-condition parameters such as pressure and temperature must be sensed accurately and reliably, and the sensed information must be converted into a suitable form of signal which is transmitted via a suitable link provided at each wheel. The information must be conveyed to the dashboard and converted into a form suitable for display. An overall accuracy of about ±2% should desirably be maintained. In addition, the complete system must be implemented within certain constraints of size and weight to operate in the electronically and environmentally inhospitable environment of the vehicle. To be applicable to mass-market vehicles the system must also be cheap.

Various forms of tyre condition sensing apparatus have been proposed. Most of these designs employ a wireless link at each wheel to transmit the sensed information from the wheel to the vehicle chassis. The use of a radio link as the wireless link is possible, but radio is pervasive and has electro-magnetic compatibility (EMC) pollution problems at high vehicle densities. Accordingly, it is generally preferable to employ a capacitive or inductive coupling as the wireless link for conveying the sensed information.

Tyre condition sensing apparatus that has a capacitive or inductive coupling may have a sensor module mounted on the vehicle wheel, and a relay module mounted on the wheel axle. The relay module controls the wireless link to the sensor module. There is generally one sensor module and one relay module per vehicle wheel, possibly including the vehicle's spare wheel. In the case of the spare wheel, the relay module is mounted somewhere in the storage compartment of the spare wheel, rather than on the vehicle axle.

The sensing apparatus normally further includes a central module or display module provided in common for all the vehicle wheels whose tyre conditions are being sensed. This display module is generally located in the vicinity of the vehicle dashboard. The display module processes information from the relay modules and controls a display at the dashboard. Connections are made between each relay module and the display module. These connections are used to transmit power from the display module to the relay module and to transmit information signals representing the sensed information from the relay module to the display module.

Preferred designs of tyre condition sensing apparatus are described in detail in our copending PCT application no. PCT/GB00/00450, the entire content of which is incorporated herein by reference.

It is desirable in tyre condition sensing apparatus of the kind described above for the indications of tyre condition to be as simple and convenient as possible for the vehicle operator to understand. It is also desirable to make the apparatus as simple and convenient as possible to install on the vehicle, without extensive redesign of or addition to the vehicle wiring looms.

According to a first aspect of the present invention there is provided tyre condition indicating apparatus, adapted to be carried by a vehicle, comprising: an indicator; and indicator control means connected with the indicator and operable, in dependence upon information relating to tyre condition, to change the indicator between a first state, in which the indicator is deactivated constantly, and a second state, in which the indicator is activated constantly, and a third state in which the indicator is activated intermittently.

According to a second aspect of the present invention there is provided a vehicle having an audio indicator for providing an audio indication of a tyre condition of a wheel of the vehicle, the indicator being arranged so that its indication of tyre condition is audible externally of the vehicle in the vicinity of the said wheel.

According to a third aspect of the present invention there is provided sensing apparatus, adapted to be carried by a vehicle, comprising: a connection wire; a brake pad wear detector operable to make an electrical connection between said connection wire and a source of predetermined potential when a brake pad of a vehicle wheel is in a worn condition; a tyre condition detector connected to said connection wire and operable to bring about a change in a signal carried by the connection wire in dependence upon a tyre condition of the said wheel; and processing means connected to the said connection wire and operable to detect when said electrical connection is made by said brake pad wear detector and to produce a first indication in response to such detection, and further operable to detect such a change in the said signal and to produce a second indication in dependence upon the detected change.

According to a fourth aspect of the present invention there is provided tyre condition sensing apparatus, adapted to be carried by a vehicle that comprises a connection wire, extending between a wheel region of the vehicle and a dashboard region of the vehicle and also comprises a brake pad wear detector operable to make an electrical connection between said connection wire and a source of predetermined potential when a brake pad of the said wheel is in a worn condition, the tyre condition sensing apparatus comprising: a tyre condition detector for connection, when the apparatus is in use, to said connection wire and operable to bring about a change in a signal carried by the connection wire in dependence upon a tyre condition of the said wheel; and processing means for connection, when the apparatus is in use, to the said connection wire and operable to detect such a change in the said signal and to produce an indication of tyre condition in dependence upon the detected change.

According to a fifth aspect of the present invention there is provided tyre condition indicating apparatus, adapted to be carried by a vehicle, comprising: a first module having an audio indicator for providing an audio indication of a tyre condition of a wheel of the vehicle and also having audio indicator activation means for activating said audio indicator, the audio indicator being arranged so that its indication of tyre condition is audible externally of the vehicle in the vicinity of the said wheel; a second module having a second indicator for indicating a tyre condition of the said wheel, second indicator activation means for activating said second indicator, and control means, connected operatively to said audio indicator activation means, for supplying a remote control signal to said audio indicator activation means to bring about activation of the said audio indicator, the said second indicator being arranged so that its indication of tyre condition is perceivable in a driver/passenger compartment of the vehicle; and a connection wire, connecting said first module to said second module, through which power is supplied to said first module from said second module; wherein: said control means are operable to supply said remote control signal by changing a power supply voltage applied by said second module to said first module via said connection wire; and said audio indicator activation means are operable to detect such a change in power supply voltage and to activate the said first indicator in response to such detection.

In such apparatus a tyre condition detector (e.g. in a further module) may be additionally connected to said connection wire. The detector is operable to bring about a change in a signal carried by the is connection wire in dependence upon a tyre condition of the said wheel. The second module may have processing means connected to the said connection wire which cause the said indicators to produce indications in dependence upon the detected change. The signal change is preferably a change in current flowing through the said connection wire. The tyre condition detector may bring about such signal changes at a frequency dependent upon the said tyre condition, and the said processing means may be operable to detect the frequency of such signal changes and to cause the said indicators to produce indications in dependence upon the detected frequency.

Reference will now be made, by way of example, to the accompanying drawings, in which:

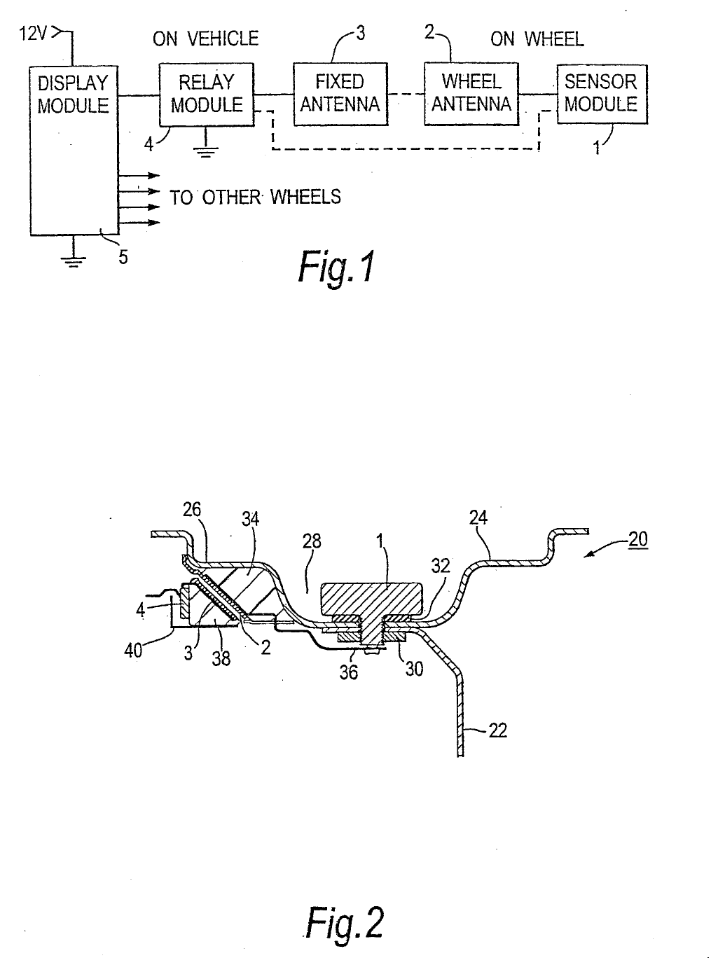

FIG. 1 shows a block diagram of tyre condition indicating apparatus embodying the present invention;

FIG. 2 shows a schematic cross-sectional view of a vehicle wheel, for explaining a physical arrangement of parts of the FIG. 1 apparatus in one embodiment of the present invention;

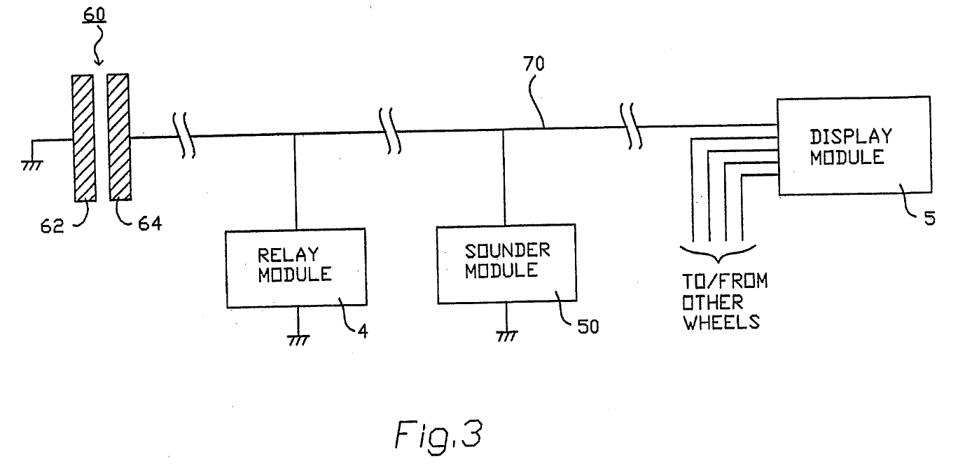

FIG. 3 shows a block circuit diagram of parts of the FIG. 1 apparatus, for explaining an electrical connection between the parts in one embodiment of the invention;

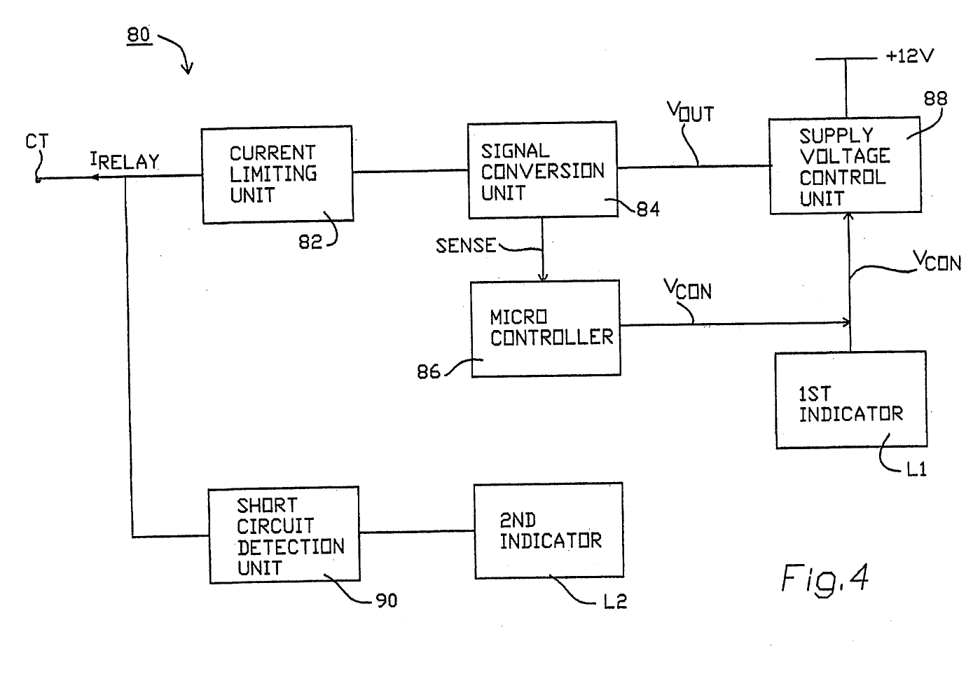

FIG. 4 shows a block circuit diagram of parts of a display module included in the FIG. 1 apparatus;

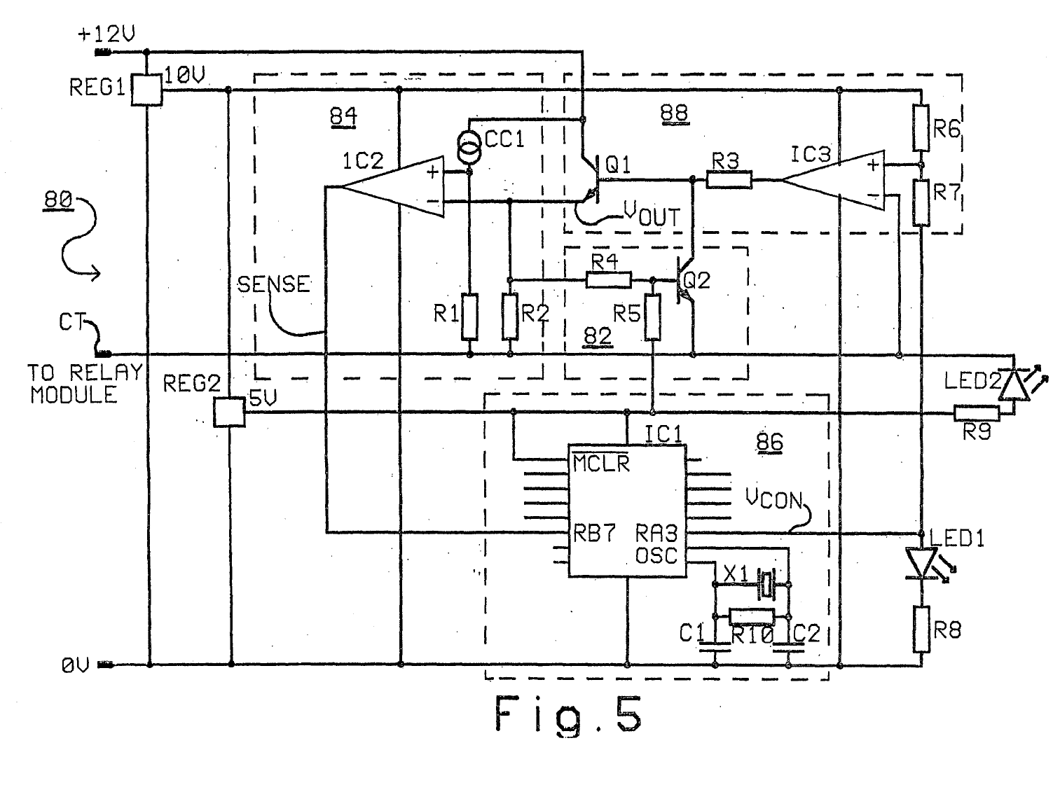

FIG. 5 is a detailed circuit diagram corresponding to FIG. 4;

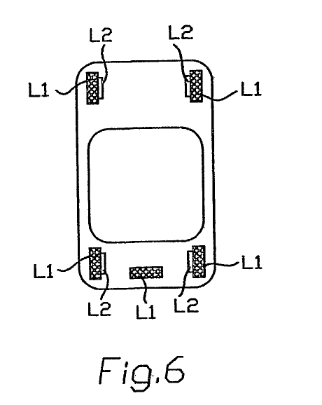

FIG. 6 shows an example of an indicator display layout in one embodiment of the present invention;

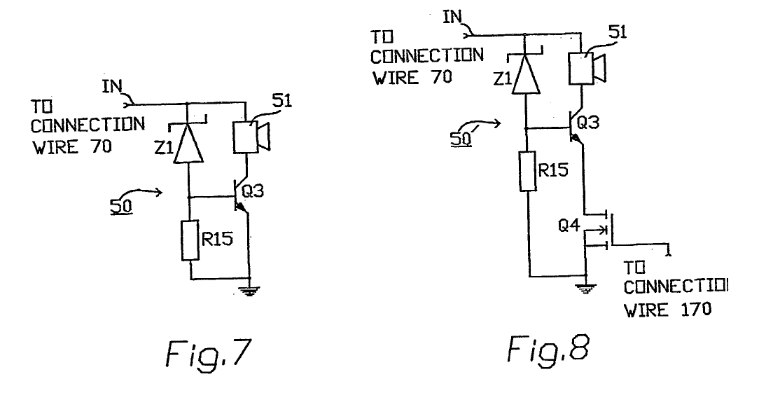

FIG. 7 is a detailed circuit diagram of one of the parts shown in FIG. 3;

FIG. 8 is a detailed circuit diagram for use in explaining a modification to the FIG. 7 part; and

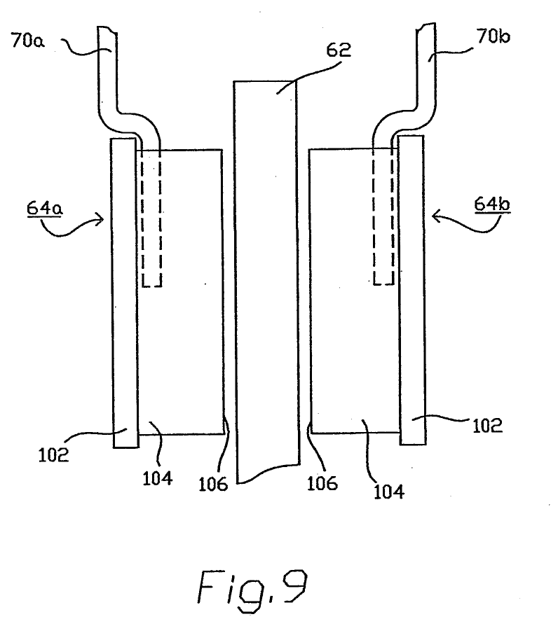

FIG. 9 is a schematic cross-sectional view of a brake wear detector for a vehicle wheel.

The FIG. 1 tyre-condition indicating apparatus comprises five principal elements: a sensor module 1, a wheel antenna 2, a fixed antenna 3, a relay module 4 and a display module 5. The sensor module 1, wheel antenna 2, fixed antenna 3 and relay module 4 are provided on a per-wheel basis; the display module 5 is provided in common for all wheels. The sensor module 1 and wheel antenna 2 are mounted on the relevant wheel and the fixed antenna 3, relay module 4 and display module 5 are carried by the vehicle.

For the purposes of explanation, it will be assumed that the tyre conditions to be sensed are tyre pressure and temperature, but it will be understood that any parameters relating to tyre condition can be sensed in apparatus embodying the present invention.

The sensor module 1 is mounted on a particular wheel. Preferably, the module is arranged in the well of the wheel rim, but alternatively the module can be arranged externally of the tyre with pressure and thermal connections to the air contained in the tyre. The sensor module contains sensors that respond to pressure and temperature, as well as circuitry for producing one or more signals whose frequency is a function of pressure and temperature. The sensor module also includes load circuitry, in the form of a resonator, whose impedance varies according to the signals produced, and means for deriving a power supply from the load.

The relay module 4, which is coupled reactively to the sensor module by the antennae 2 and 3, serves to drive the load circuitry in the sensor module 1 and to detect the variation in loading and convert this variation into a signal suitable for use by the display module 5. The relay module can be mounted on the axle, close to or as part of the fixed antenna 3.

The relay module 4 contains driver circuitry to provide a high-frequency voltage and current to the fixed antenna 3 via a source impedance, and circuitry to detect the variation in loading of the relay module and to supply a signal representing the variation to the display module 5.

The display module 5 processes the signals from the relay module for each wheel, applies any required signal corrections and displays the information to the driver. The display module is preferably mounted on, or behind the dash, in close proximity to or integrated with the actual display. The display module may, for example, be implemented as a single-chip microcontroller, or as part of an existing microcontroller that also performs other driver-information functions.

Next, coupling between the sensor module 1 on the or each wheel and its associated relay module 4 on the vehicle will be explained. This coupling must serve to transmit at least one signal from the sensor module 1 to the relay module 4, from which signal the relay module can derive the relevant sensing parameter(s) produced by the sensor module 1.

Furthermore, in a preferred embodiment, the coupling also serves to transmit power from the vehicle to the sensor module 1.

As the vehicle wheels rotate relative to the vehicle axles when the vehicle is in use it is preferable that the coupling between the sensor and relay modules is by non-contact means so that wear is eliminated. Two non-contact coupling methods can be used to transmit power in one direction and receive a signal in the other direction: capacitive coupling and magnetic coupling. Radio, which is used in some conventional tyre pressure measurement systems, can only effectively be used to transmit signals and requires a local power source (battery) in the wheel. Furthermore, radio is by its nature a pervasive medium and presents additional-problems.

Capacitive coupling is the preferred coupling method for use in the present invention. This can be achieved simply by the use of conducting plate antennae separated by an air gap. The electric potential on one plate produces a localised electric field that induces a potential on the other. The plates themselves can be protected by being covered by an insulating material. The plates do not have to be planar or of the same size.

Antennae in the form of simple conducting plates are far less prone to electromagnetic interference than coils.

It is also possible to use magnetic induction between two closely-spaced concentric coils, one mounted on the axle and the other on the wheel. With this method, the sensor module 1 on the wheel and the relay module 4 on the axle are coupled when the magnetic field from one coil links with the other coil. In practice, magnetic coupling may be difficult to arrange because of the positions at which brake components are normally arranged on the wheels. Large diameter coils could be used to avoid the brake components but these are particularly susceptible to electromagnetic interference.

Both with capacitive and magnetic coupling, only AC currents can be transmitted through the coupling.

Transmission of power through the coupling is achieved by the relay module (source) applying an alternating voltage to the coupling, and by the sensor module (load) taking a current from the coupling.

Transmission of information from the load back to the source is carried out by varying the load. If the current taken by the load must come from the source, it follows that measurement of this current at the source will show any variation in the load. This is the principle on which most passive sensors operate, i.e. the sensor impedance changes according to the parameter being sensed the electrical load presented by the sensor is measured.

FIG. 2 is a schematic cross-sectional view illustrating an example of the possible physical arrangement of the sensor module 1, the wheel antenna 2, the fixed antenna 3 and the relay module 4 in relation to a vehicle wheel 20. The wheel 20 has a flange 22, an outer rim 24, an inner rim 26 and a well 28 between the outer and inner rims 24 and 26.

The sensor module 1 which is mushroom-shaped has an externally-threaded base portion which projects through a hole in the well 28 and is retained in place by a retaining nut 30. A seal 32 is provided between the base of the sensor-module head and the well 28 to provide an airtight seal between the sensor module and the wheel.

The sensor module 1 in FIG. 2 preferably has a metal casing which provides its earth connection directly to the wheel well 28.

Incidentally, it will be appreciated that in the FIG. 2 arrangement the earth connection for the sensor module 1 (return path) is implemented through the wheel bearing. Although this is unreliable as an ohmic connection alone, it will operate satisfactorily as a capacitive connection in parallel with an ohmic connection at the frequencies proposed.

The wheel antenna 2 is shaped as the frustum of a cone so as to fit under the inner rim 26 of the wheel. The wheel antenna 2 is intended to snap into the recess in the underside of the rim 26 formed by the bead retaining hump used on modern wheels. The width of the wheel antenna 2 may be, for example, 20 mm. By making the wheel antenna 2 conical, fitment of the wheel is kept simple and the coupling to the fixed antenna will be less susceptible to axial run out of the wheel rim than if a plane antenna was used. In addition, the antennae surfaces will be self-draining both when stationary and rotating, and there is no interference with wheel balancing weights.

The wheel antenna 2 is supported by polymer backing material 34 between the inner rim 26 and the rear face of the wheel antenna 2. An electrical connection (a single wire) 36 extending between the base portion of the sensor module 1 and the rear face of the wheel antenna 2 connects the wheel antenna 2 to the circuitry inside the sensor module.

The fixed antenna 3 is supported by more polymer backing 38 on a mounting bracket 40. In this embodiment a fixed antenna 170 mm long is required to provide the necessary area. On a standard 13 inch wheel rim, this subtends an angle of about 60°. No modification to the axle will be required except for the provision of mounting points for the fixed antenna. These can generally be common with the brake mountings.

The relay module 4 is preferably arranged locally at the axle (i.e. is integral with the fixed antenna 3), as shown in FIG. 2. Alternatively, the relay module may be remote from the fixed antenna 3, for example integral with the display module, in which case connection to the fixed antenna will be through coaxial cable or by twisted pair.

FIG. 3 shows the electrical connection between the relay module 4 for one wheel and the display module 5 in a preferred embodiment of the present invention. Also shown in FIG. 3, in addition to the relay module 4 and display module 5, are a sounder module 50 and a brake wear detector 60.

The brake wear detector 60 is a component fitted as standard to each braked wheel of many cars and commercial vehicles. It will be assumed in the present embodiment that there is one such detector per wheel (not including the vehicle's spare wheel). In the detector 60 a brake disk 62 is connected electrically to the vehicle chassis (which is the vehicle earth). A brake pad 64 has one end of a connection wire 70 bonded to it. When the brake pad 64 is in a normal (non-worn) condition the connection wire 70 is electrically isolated from the brake disk 62 by the brake pad 64. However, when the brake pad becomes excessively worn, the brake pad 64 no longer serves to provide electrical isolation, and the connection wire 70 becomes short-circuited to the vehicle earth when the brake is applied.

Conventionally, this short-circuit condition is detected by a short-circuit detection circuit connected to the other end of the connection wire 70. This short-circuit detection circuit generally forms part of a driver information system provided at, or in the vicinity of, the vehicle dashboard. When such a brake wear detector 60 is provided at each of two or more wheels, the respective connection wires 70 may be connected in common (wire-ORed) at the dashboard end, in which case a single short-circuit detection circuit can detect when any of the wheels concerned has an excessively-worn brake pad.

The present embodiment takes advantage of the fact that, in vehicles having such brake wear detectors 60, there is already a connection wire 70 extending between the vehicle dashboard and each wheel having a brake wear detector. This connection wire can be used to connect the display module 5 of the FIG. 1 apparatus to the relay module 4 and, optionally, to the sounder module 50.

As shown in FIG. 3, for each wheel having a brake wear detector 60, a connection wire 70 is connected at one end to the detector 60 and at the other end to the display module 5. At any convenient location along the connection wire 70 the relay module 4 for that wheel is connected. Similarly, at any convenient location along the wire 70 the sounder module 50 for that wheel is connected. The relay module 4 and sounder module 50 for each wheel also each have a local earth connection to the vehicle chassis.

FIG. 4 shows a block circuit diagram of processing circuitry in the display module 5 of FIG. 3. The FIG. 4 processing circuitry 80 comprises a current limiting unit 82, a signal conversion unit 84, a microcontroller 86, a supply voltage control unit 88, a short circuit detection unit 90 and respective first and second indicators L1 and L2. In this embodiment the indicators L1 and L2 are visual indicators such as light-emitting diodes but audio and other indicators can be used instead of or in addition to visual indicators.

In FIG. 4, all of the elements except for the microcontroller 86 are provided on a per-wheel basis. The microcontroller 86 is provided in common for all wheels.

Operation of the processing circuitry 80 will now be described. The circuitry operates in one or two different modes: a normal mode and short-circuit mode.

The circuitry 80 operates in the normal mode until the brake pad (64 in FIG. 3) for the wheel becomes excessively worn. In the normal mode, there is no short circuit between the connection wire 70 and the vehicle earth. In this normal mode, the processing circuitry 80 supplies power via the connection wire 70 to the relay module 4 and the sounder module 50; receives one or more tyre-condition sensing parameters from the relay module 4 via the connection wire 70; and controls the operation of the sounder module 50 remotely via the connection wire 70.

As described in detail in our co-pending PCT application no. PCT/GB00/00450, the relay module 4 may include a current sink circuit which modulates a current drawn by the relay module 4 from the display module 5 according to one or more tyre-condition sensing parameters sensed by the sensor module 1 for the wheel. For example, the current drawn by the relay module 4 may be amplitude-modulated between respective high and low values, the frequency of the current variation being dependent upon the tyre-condition sensing parameter(s). The frequency of variation may be of the order of 1 kHz to 40 kHz and may vary by a factor of 2 as the tyre-condition sensing parameter varies between its minimum and maximum values.

The high and low current values may each be fixed values (e.g. 100 mA and 40 mA) or, if desired, one or both of the high and low values may be dependent upon a sensing parameter. For example, as described in our above-mentioned PCT application, the low current value may be variable in dependence upon ambient temperature as measured in the relay module 4.

The current drawn by the relay module 4 is supplied by the supply voltage control unit 88. The supply voltage control unit 88 has a power input which is connected to a power supply line of the display module 5, for example the positive supply line (+12V). The supply voltage control unit 88 also has a control input which is connected to an output of the microcontroller 86 for receiving therefrom a control signal VCON. The control signal VCON is also applied to the indicator L1. The supply voltage control unit 88 also has a power output at which an output voltage VOUT of the unit is generated. The magnitude of the output voltage VOUT is varied between predetermined high and low values in dependence upon the control signal VCON applied to the control input unit 88.

The output voltage VOUT is supplied via the signal conversion unit 84 and the current limiting unit 82 to a connection terminal CT of the circuitry 80. Thus, the connection-terminal potential is changed between respective high and low values as the output voltage VOUT is changed by the supplied voltage control unit 88. The connection wire (70 in FIG. 3) connecting the circuitry 80 to the relay module 4, sounder module 50 and brake wear detector 60 is connected at one end to the connection terminal CT.

The current I_{RELAY} drawn by the relay module 4 from the supply voltage control unit 88 passes through the signal conversion unit 84. The signal conversion unit 84 performs a predetermined signal conversion to convert the drawn current I_{RELAY} into a signal SENSE suitable for application to the microcontroller 86. For example, when the high and low values of the current drawn are both fixed, the SENSE signal may simply be a logic signal having one logic state (e.g. the high logic state H) when the current drawn has the high value, and has the other logic state (e.g. the low logic state L) when the current drawn has the low value. Such a digital signal SENSE changes logic state at the same frequency as the variations in the drawn current I_{RELAY}, so that, by measuring the frequency of state changes in the digital signal SENSE, the microcontroller can measure the frequency of changes in the current drawn I_{RELAY}. For example, the microcontroller 86 may count the number of state changes that occur in the SENSE signal over a predetermined time period to measure the frequency. The required tyre-condition sensing parameter (e.g. tyre pressure) may then be derived from the measured frequency using a look up table or conversion formula.

In the processing circuitry 80, the indicator L1 is used to indicate the tyre condition sensed in this way. The indicator L1 can have one of three states. In the first state, the indicator L1 is activated constantly. This state corresponds to the sensed parameter (e.g. pressure) being too high relative to a nominal value set for the parameter. In the second state, the indicator L1 is deactivated constantly. This state denotes that the sensed parameter has a satisfactory (near nominal) value. In the third state the indicator L1 is activated intermittently. This state denotes that the sensed parameter is too low relative to the nominal value.

In the third state, the frequency of intermittent activation of the indicator L1 may be dependent upon the amount by which the sensed parameter differs from its nominal (intended) value. For example, the activation frequency may increase as the amount of difference from the nominal value increases.

The microcontroller 86 uses the VCON control signal to turn on and off the indicator L1. When the control signal VCON has the high logic state the indicator L1 is turned on, and when the control signal VCON has the low logic state L the indicator L1 is turned off. Also, when the VCON signal has the high logic state H the output voltage VOUT of the supply voltage control unit 88 has the high value, whereas when the VCON control signal has the low logic state L the output voltage VOUT has the low value.

This completes operation in the normal mode.

In the short-circuit mode of operation, the connection terminal CT is short circuited to vehicle earth via the brake wear detector 60. In this mode, the short circuit is detected by the short circuit detection unit 90, which causes the second indicator L2 to be turned on.

In the short circuit mode, the current limiting unit 82 prevents the amount of current drawn I_{RELAY} from the connection terminal CT from exceeding a predetermined value.

Incidentally, it will be appreciated that, in the short-circuit mode, the relay module 4 and sounder module 50 no longer receive a normal power supply voltage through the connection wire 70. Accordingly, the relay module 4 and sounder module 50 are inoperative in the short-circuit mode.

Incidentally, U.S. Pat. No. 4,334,428 describes a tyre pressure monitoring system incorporating an arrangement for monitoring brake pad wear as well. In this system, a pressure-sensitive circuit carried by the wheel is coupled inductively by a coil carried on a ring to an interrogation circuit carried by the vehicle. A brake circuit, separate from the pressure-sensitive circuit, is mounted on the vehicle and has a resonator with a resonant frequency that is changed when the brake pad becomes worn. The brake circuit is also coupled inductively to the interrogation circuit via the coil. The interrogation circuit supplies the ring with each of the frequencies at which the brake circuit may resonate, as well as supplying a different resonant frequency to the pressure-sensitive circuit, to detect both brake pad wear and tyre pressure.

Although FIG. 4 schematically shows the connection path between the power output of the supply voltage control unit 88 passing through the current limiting unit 82 and the signal conversion unit 84, it will be appreciated that the order in which the units 82, 84 and 88 are connected to the connection terminal may be different from that shown in FIG. 4.

FIG. 5 shows a detailed circuit diagram corresponding to FIG. 4 in one embodiment of the present invention. An exemplary component list for use in the FIG. 5 circuitry is given in Table 1 overleaf.

TABLE 1

| Element | Component Value/Type |
|---|---|
| R1 | 470R |
| R2 | 4R7 |
| R3 | 820R |
| R4 | 2K0 |
| R5 | 30 K |
| R6 | 10 K |
| R7 | 20 K |
| R8 | 470R |
| R9 | 470R |
| R10 | 1 M |
| C1 | 6pF8 |
| C2 | 6pF8 |
| X1 | 4 MHz |
| Q1 | BC337 |
| Q2 | BC546 |
| IC1 | PIC18C621 |
| IC2 | LM339 |
| IC3 | MC33204 |
| REG1 | 10 V |
| REG2 | 5 V |
| CC1 | CR062 |

In FIG. 5, the supply voltage control unit 88 is made up of an amplifier element IC3, resistors R6, R7 and R3, and a transistor Q1. The amplifier IC3 has its inverting input connected to the connection terminal CT, and its non-inverting input connected to an output RA3 of the microcontroller 86 for receiving therefrom the control signal VCON. The resistors R6 and R7 form a potential shifting circuit which causes the inverting-input potential to have the value 8.33V when the VCON signal has the high logic state H, and to have the value 6.66V when the VCON signal has the low logic state L.

The output of the amplifier IC3 is applied, via the resistor R3, to the base of the transistor Q1 which is connected in an emitter-follower configuration. The output voltage VOUT of the unit 88 is produced at the emitter of the transistor Q1. The emitter of Q1 is connected to the connection terminal CT via a further resistor R2, forming part of the signal conversion unit 84. Thus, the resistors R2 and R3 and the transistor Q1 are connected in a negative-feedback loop around the amplifier IC3 so that the amplifier IC3 functions as a voltage follower which maintains the connection-terminal potential substantially equal to the non-inverting input potential of the amplifier IC3, i.e. 8.33V when VCON has the H state and 6.66V when VCON has the L state. The potential VOUT at the emitter of the transistor Q1 will be marginally higher than the connection-terminal potential due to the voltage drop across the resistor R2.

The signal conversion unit 84 comprises the above-mentioned resistor R2, a further resistor R1, a constant-current source CC1 and a comparator IC2. The constant current source CC1 causes a constant reference current of 0.62 mA to flow through the resistor R1. A variable current, equal to the current drawn by the relay module 4 from the power supply control unit 88, flows through the resistor R2. As the resistors R1 and R2 have a resistance ratio of 100:1, the potential at the positive input of the comparator IC2 exceeds the potential at the negative input thereof when the current drawn by the relay module 4 is less than 100 times the reference current, i.e. less than 62 mA. The signal SENSE produced at the output of the comparator IC2 is a digital signal which has the high logic state H when the positive-input potential exceeds the negative-input potential, i.e. when the current drawn I_{RELAY}<62 mA. When the current drawn I_{RELAY}>62 mA the SENSE signal has the low logic state L.

The switching threshold (62 mA) of the comparator IC2 is chosen to be close to midway between the low and high values of the current drawn by the relay module 4 (e.g. 40 and 100 mA respectively)

Incidentally, it will be seen that the comparator IC2 is powered from a 10 volt supply voltage supplied by a first voltage regulator REG1. The microcontroller 86, on the other hand, is powered from a lower supply voltage (+5V) provided by a second regulator REG2. The output of the comparator IC2 is, however, of the open collector type and a microcontroller device IC1 in the microcontroller 86 has internal pull-up resistors at its inputs (including the input RB7 connected to the comparator output). Accordingly, when the SENSE signal has the H state, the RB7 input is pulled up to +5V by an internal pull-up resistor in the microcontroller device IC1, so that the output of the comparator IC2 is compatible with the input of the microcontroller device IC1 despite the fact that the two circuits are powered from different supply voltages.

The microcontroller 86 includes, in addition to the microcontroller device IC1, a clock circuit made up of a crystal X1, a resistor R10 and capacitors C1 and C2. In this embodiment, the frequency f_{clock} of the clock signal applied to the microcontroller device IC1 is 4 MHz.

The microcontroller device IC1 operates in accordance with a program to carry out a series of sensing cycles, each sensing cycle serving to sense one or more tyre-condition parameters for one of the vehicle wheels, and the vehicle wheels being processed in turn one after the next. In the microcontroller 86, a frequency divider circuit (not shown) divides the clock frequency f_{clock} by a factor of 2048 and applies interrupts to the microcontroller device IC1 at the rate of f_{clock}/2048. The duration of each sensing cycle is 50 interrupts, i.e. 25.6 ms. The microcontroller device IC1 counts the number of state changes in the SENSE signal over that 25.6 ms cycle and converts the count value into a tyre-condition sensing parameter for the wheel concerned. This conversion may be carried out using a look-up table or a conversion formula. The tyre-condition sensing parameter so produced is then compared with a nominal value for that parameter which may be supplied from another look-up table. Alternatively, the nominal value may be held in a memory (not shown) associated with the microcontroller device IC1. This memory may be, for example, an electrically erasable programmable read only memory (EEPROM) device, so that the nominal value can be changed from time to time, e.g. if a replacement tyre of a new type is fitted to the vehicle or if the loading conditions of the vehicle are changed.

If the result of the comparison between the sensed value and the nominal value is that the sensed value exceeds the nominal value by more than a predetermined margin (upper margin) the microcontroller device IC1 sets the VCON control signal for the wheel concerned to the H logic state so that the indicator LED1 is activated constantly. If, on the other hand, the result of the comparison is that the sensed value is lower than the nominal value by a predetermined margin (lower margin), which may be the same or different from the upper margin, the microcontroller device IC1 toggles the VCON control signal between the H and L states. For example, the microcontroller device may have a counter for each wheel which is incremented at each interrupt by an amount dependent on the difference between the sensed value and the nominal value. When the count value reaches a predetermined threshold, the state of the VCON signal is inverted and the counter is reset. In this way, the greater the difference between the sensed value and the intended value the greater the flashing rate of the indicator LED1.

Finally, if the sensed value is within the upper and lower margins of the nominal value, the microcontroller device IC1 sets the VCON control signal to the L state, so that the indicator LED1 is maintained in the off condition constantly.

It is preferable that the upper margin is in fact a selected one of two different available upper margins, a first one of which (inner upper margin) is smaller than the second (outer upper margin). The selection of one of the two upper margins is dependent on the existing indicator state (i.e. on/off/intermittent). If the indicator is in the on state, the inner upper margin is selected so that no change to the off state occurs until the sensed value has fallen to within the inner upper margin of the nominal value. On the other hand, when the indicator is in the off state, the outer upper margin is selected so that a change to the on state occurs only when the sensed value exceeds the nominal value by more than the outer upper margin. Such use of hysteresis for the upper margin is desirable because it avoids possible confusion between the indicator states when the sensed value just exceeds the nominal value by the upper margin. In that case, without hysteresis, the indicator would tend to alternate between the on and off states, which could be misinterpreted as the intermittent state corresponding to the sensed value being too low.

The lower margin may also be implemented using hysteresis. In this case, when the indicator is in the flashing state, an inner lower margin is selected so that a change to the off state occurs only when the sensed value rises to within the inner upper margin of the nominal value. When the indicator has the off state, on the other hand, an outer lower margin, greater than the inner lower margin, is selected so that a change to the intermittent state occurs only when the sensed value is lower than the nominal value by the outer lower margin. In the case in which the sensed value differs from the nominal value by an amount close to the lower margin, such use of hysteresis can prevent potentially-misleading changes in indicator state from occurring. In particular, if the rate of intermittent activation in the intermittent state is dependent on the difference the sensed value and the nominal value, “noisy” switching between the off and intermittent states could lead to a rate of intermittent activation that is different from the intended rate, if no hysteresis is used.

Vehicles and tyres may be specified with both a normal inflation pressure and a high-loading inflation pressure greater than the normal inflation pressure. The high-loading inflation pressure is chosen when the vehicle is highly loaded. Upper and lower margins with hysteresis, as described above, can enable changes to be made by a vehicle operator between the normal and high-loading pressures without changing the nominal value that the sensed value is compared against. For example, assuming that the tyre is initially inflated to the normal pressure, a change to the high-loading pressure can be made as follows. Firstly, the operator deliberately over-inflates the tyre until the indicator has the on state. Then, the tyre is deflated until the indicator changes to the off state. Deflation is stopped as soon as the off state is entered. At this point, it is known that the difference between the sensed value and the nominal value is now just below the inner upper margin. Thus, by setting this inner upper margin such that the sum of its value and the nominal value is approximately equal to the specified high-loading pressure, inflation to that pressure can be carried out reliably.

Similarly, when the pressure is to be changed from the high-loading pressure to the normal pressure, the operator first deflates the tyre until the indicator enters the intermittent state. Then, the tyre is inflated again until the indicator state just changes from the intermittent state into the off state. At this point it is known that the difference between the sensed value and the nominal value is just less than the inner lower margin. Thus, by setting the inner lower margin such that a value obtained by subtracting the inner lower margin from the nominal value is equal or close to the desired normal pressure, inflation to the normal pressure can be achieved reliably.

Incidentally, as an alternative to the above, it is possible to have two nominal values, one relating to the normal inflation pressure and the other relating to the high-loading inflation pressure. In this case, a dash-mounted pushbutton or toggle switch connected with the microcontroller 86 may be used to select the appropriate one of the nominal values depending on the loading condition of the vehicle. These two values may be stored in the memory (EEPROM) device.

In the FIG. 5 embodiment, the indicator LED2, used to indicate brake wear, simply has its anode connected to the +5V supply via the resistor R9 and its cathode connected directly to the connection terminal CT. When the circuitry is operating in the normal mode (brake pad not worn) the indicator LED2 is reverse-biased as the connection-terminal potential is either 8.33V or 6.66V. In the short-circuit mode, on the other hand, the connection-terminal potential falls below +5V so that the indicator LED2 becomes forward-biased and accordingly illuminates.

In this condition, the current I_{RELAY} is limited by the current limiting unit 82. This unit comprises resistors R4 and R5 and a transistor Q2.

In the short-circuit condition, the emitter of the transistor Q2 drops below 5V and the current flow through the resistor R5 reverses in direction. In this condition, the transistor Q2 turns on strongly, clamping the base-emitter voltage of the transistor Q1 to a low value and hence limiting its power dissipation.

Incidentally, the current limiting unit 82 also operates during the normal mode, as well, but with a current limit sufficiently high that the relay module and sounder module operate normally. The base-emitter voltage of the transistor Q2 is determined by the resistors R4 and R5, and by the current I_{RELAY} flowing through the resistor R2 in the signal conversion unit 84. As the current I_{RELAY} increases, the base-emitter voltage V_{BE} increases until Q2 starts to turn on. As the transistor Q2 turns on, it reduces the base-emitter voltage seen by the transistor Q1 and so limits the current flowing through the transistor Q1 to a safe value that is dependent on the output voltage and therefore the voltage across Q1.

FIG. 6 shows an example layout of the indicators in an embodiment of the invention. In this example layout, a display at the dashboard has a schematic view of the vehicle showing the approximate positions of the wheels in relation to the vehicle chassis. Each road wheel has a pair of indicators made up of a larger indicator L1 for indicating tyre condition (e.g. tyre pressure) and a smaller indicator L2 for indicating brake pad wear. The spare wheel has only a tyre-condition indicator L1 and no brake pad wear indicator L2. The indicators L1 may be different in colour and/or shape from the indicators L2. For example, the indicators L1 may be rectangular and the indicators L2 may be triangular.

When there is a fault with any of the wheels, the relevant indicator L1 or L2 will become illuminated, enabling the vehicle driver to identify the faulty wheel and the nature of the fault quickly and conveniently.

Next, an embodiment of the sounder module 50 in FIG. 3 will be described with reference to FIG. 7. The function of the sounder module 50 is to provide audible indications for its particular wheel that correspond to the visual indications provided by the tyre-condition indicator L1 for that wheel. The sounder module is preferably arranged so as to be audible externally of the vehicle by an operator in the vicinity of the wheel concerned, for example as the operator pumps up or inspects the tyre concerned. The sounder module may, for example, be mounted close to the relay module. The sounder module is preferably separate from the relay module so that the respective locations of the relay module and sounder module can be chosen freely and independently of one another, rather than as a compromise.

Referring to FIG. 7, the sounder module 50 comprises a Zener diode Z1, a resistor R15, a transistor Q3 and an audio transducer S1. The Zener diode is for example a 7V5 diode, the resistor R15 is for example 1KΩ, the transistor is for example type BC546 and the transducer is for example type Euroind EI-242-B.

The sounder module 50 has an input IN which is connected to the connection wire 70 (FIG. 3) for its particular wheel. The Zener diode Z1 produces a predetermined voltage drop of 7.5V, so that the base voltage of the transistor Q3 is 7.5V lower than the potential of the connection wire 70. As described above with reference to FIG. 5, the connection-terminal potential (and hence the connection-wire potential) is varied under the control of the microcontroller 86 between a high value of +8.33V and a low value of +6.66V. When the connection-wire potential has the low value, the base voltage of the transistor Q3 is too low to turn that transistor on. Accordingly, no sound is produced by the transducer S1. On the other hand, when the connection-wire potential has the high value, the base voltage of the transistor Q3 is high enough (e.g. 0.8V) to turn that transistor on, so that sound is produced by the transducer S1.

Referring back to FIGS. 4 and 5, it can be seen that, as the changes in the connection-wire potential are brought about by the control signal VCON used to activate the indicator L1, the transducer S1 emits sound whenever the indicator L1 emits light. Accordingly, the sounder module has the same three indication states as the display module (i.e. a first state (constant sound output) indicating that the sensed parameter is too high; a second state (no sound emitted at all) indicating that the sensed parameter is at or close to its nominal value; and a third state (intermittent sound) indicating that the sensed parameter is too low). As with the visual indication, the rate at which the audio indications are produced may be varied according to the difference between the sense value and the nominal value.

FIG. 8 shows a modification to the FIG. 7 sounder module. In this modification, a field-effect transistor Q4 is incorporated between the emitter of the transistor Q4 and earth. The gate of the transistor Q6 is connected via a separate connection wire 170 to the relay module 4 for the wheel concerned. For example, the additional connection wire 170 may be connected to a signal line in the relay module which is used to control the current sink therein (described above with reference to FIG. 3). When the current sink is controlled to set the current drawn to the low value (e.g. 40 mA) the gate of the transistor Q4 in the sounder module 50 is set to the low logic state, turning the transistor Q4 off. In this case, even if the potential of the connection wire 70 has the high value (+8.33V) the transistor Q3 is prevented from being turned on when the current drawn has the low value.

This modification is useful if the current drawn by the transducer S1 is sufficiently high that, when activated, it would cause the current drawn from the display module to exceed the threshold (e.g. 62 mA) set in the signal conversion unit 84 of the relay module. Also, if the low value of the current drawn is varied in dependence upon a sensed parameter, then it is necessary to be able to measure the low-value current in the display module. For this reason also it is desirable to prevent the current drawn by the sounder module from affecting the measurement of the low-current value.

It will be appreciated that the sounder module may be controlled remotely by the display module in many ways other than changing the connection-wire potential. For example, the sounder module could receive any kind of remote control signal from the display module via the connection wire.

It is also not essential that the sounder module indicator (transducer S1) be placed in the same state as the corresponding indicator in the display module. For example, the sounder-module indicator could have just two states (off and on; or off and intermittently on) to indicate a correct value and an incorrect value of the sensed parameter respectively.

It is also not essential to provide the brake pad wear detection and associated parts of the circuitry in FIG. 4 (e.g. parts 82, 90 and L2) for detecting when the brake pad is worn. In this case, the circuitry simply operates continuously in the normal mode described above with reference to FIG. 4.

FIG. 9 shows an example of the construction of the brake wear detector 60 (FIG. 3). As shown in FIG. 9, a wheel assembly includes a brake disc 62 having opposed to each of its main faces a brake pad 64a or 64b. The brake disc 62 has an electrical connection via the wheel assembly to the vehicle chassis, which is the vehicle earth.

Each brake pad 64a, 64b has a brake pad backing plate 102 having friction material 104 bonded to one main face thereof. The friction material 104 incorporates one end of an insulated wire 70a or 70b. The portion of the insulated wire 70a or 70b within the friction material 104 is set back from the working surface 106 of the friction material 104 According to a fifth aspect of the present invention there is provided tyre condition indicating apparatus, adapted to be carried by a vehicle, comprising: a first module having an audio indicator for providing an audio indication of a tyre condition of a wheel of the vehicle and also having audio indicator activation means for activating said audio indicator, the audio indicator being arranged so that its indication of tyre condition is audible externally of the vehicle in the vicinity of the said wheel; a second module having a second indicator for indicating a tyre condition of the said wheel, second indicator activation means for activating said second indicator, and control means, connected operatively to said audio indicator activation means, for supplying a remote control signal to said audio indicator activation means to bring about activation of the said audio indicator, the said second indicator being arranged so that its indication of tyre condition is perceivable in a driver/passenger compartment of the vehicle; and a connection wire, connecting said first module to said second module, through which power is supplied to said first module from said second module; wherein: said control means are operable to supply said remote control signal by changing a power supply voltage applied by said second module to said first module via said connection wire; and said audio indicator activation means are operable to detect such a change in power supply voltage and to activate the said first indicator in response to such detection.

In such apparatus a tyre condition detector (e.g. in a further module) may be additionally connected to said connection wire. The detector is operable to bring about a change in a signal carried by the connection wire in dependence upon a tyre condition of the said wheel. The second module may have processing means connected to the said connection wire which cause the said indicators to produce indications in dependence upon the detected change. The signal change is preferably a change in current flowing through the said connection wire. The tyre condition detector may bring about such signal changes at a frequency dependent upon the said tyre condition, and the said processing means may be operable to detect the frequency of such signal changes and to cause the said indicators to produce indications in dependence upon the detected frequency. which, when the brake is applied, comes into contact with the brake disc 62. As the friction material is worn away in use, eventually, a part of the end of the insulated wire 70a or 70b becomes exposed. As soon as any part of the wire end becomes exposed, any insulation on that part of the wire is stripped off by contact with the brake disc 62, and an electrical connection is made between the brake disc and the relevant wire 70a or 70b.

The two wires 70a and 70b are connected in common to a main connection wire 70 linking the brake wear detector 60 to the display module 5 (FIG. 3).

It is not essential for each brake pad 104 to have an insulated wire 70 a/b; only one of the brake pads could be provided with an insulated wire for detection purposes.

It is also not essential that the connection made when the brake pad is worn be to zero volts. For example, if the vehicle has a positive earth then the connection will be to the positive supply when the brake pad is worn. Depending on the design of wheel assembly, the connection made when the brake pad is worn could be to any suitable source having any suitable potential that can be distinguished by the processing circuitry (80 in FIG. 4) from the potentials occurring in the normal mode of operation.

1. Tyre condition indicating apparatus, adapted to be carried by a vehicle, comprising:
an indicator; and
indicator control means connected with the indicator and operable, in dependence upon information relating to tyre condition, to change the indicator between a first state, in which the indicator is deactivated constantly, and a second state, in which the indicator is activated constantly, and a third state in which the indicator is activated intermittently;
characterised in that in the said third state a rate of intermittent activation of the indicator is dependent on the value of a tyre-condition sensing parameter included in said information.

2. Apparatus as claimed in claim 1, wherein said indicator control means are operable to compare the value of the said sensing parameter with a nominal value set for that parameter, and to employ the results of the comparison to set the indicator into one of the said first, second and third states.

3. Apparatus as claimed in claim 2, wherein the said rate is dependent upon a difference between the sensing-parameter value and the said nominal value.

4. Apparatus as claimed in claim 3, wherein the said rate is increased as the said difference increases.

5. Apparatus as claimed in any one of claims 2 to 4, wherein the first state is set when the comparison results indicate that the sensing-parameter value is near to the said nominal value, the said second state is set when the comparison results indicate that the sensing-parameter value is higher than the said nominal value, and the said third state is set when the comparison results indicate that the sensing-parameter value is lower than the nominal value.

6. Apparatus as claimed in claim 5, wherein the said indicator control means include upper margin hysteresis means operable, when the indicator has said first state, to permit a change to said second state to be made when said sensing-parameter value exceeds said nominal value by an outer upper margin, and further operable, when the indicator has said second state, to permit a change to said first state to be made when said sensing-parameter value falls within an inner upper margin of said nominal value, said outer upper margin being greater than said inner upper margin.

7. Apparatus as claimed in claim 5 or 6, wherein the said indicator control means include lower margin hysteresis means operable, when the indicator has said first state, to permit a change to said third state to be made when said sensing-parameter value falls below said nominal value by an outer lower margin, and further operable, when the indicator has said third state, to permit a change to said first state to be made when said sensing-parameter value rises to within an inner lower margin of said nominal value, said outer lower margin being greater than said inner lower margin.

8. Apparatus as claimed in claim 7 when read as appended to claim 6, wherein said tyre-condition sensing parameter is a tyre-pressure parameter, and a sum of said nominal value and said inner upper margin is set to be equal or close to a specified tyre pressure under a high loading condition, and said nominal value less said inner lower margin is set equal or close to a specified tyre pressure under a normal loading condition.

9. Apparatus as claimed in any one of claims 2 to 4, wherein the said sensing parameter is a tyre-temperature parameter, and the first state is set when the comparison results indicate that the sensing-parameter value is near to the said nominal value, the said second state is set when the comparison results indicate that the sensing-parameter value is lower than the said nominal value, and the said third state is set when the comparison results indicate that the sensing-parameter value is higher than the nominal value.

10. Apparatus as claimed in any preceding claim, wherein the indicator is an audio indicator arranged, when the apparatus is in use, so that its indication of tyre condition is audible externally of the vehicle in the vicinity of the said wheel.

11. Apparatus as claimed in any preceding claim, having a plurality of such indicators, each for indicating a tyre condition of a corresponding wheel of the vehicle, and the said indicator control means are operable to set each indicator individually into one of the said first, second and third states in dependence upon information relating to the tyre condition of the wheel corresponding to that indicator.

12. Apparatus as claimed in claim 11, wherein each indicator of the said plurality is a visual indicator, and the plurality of indicators are arrayed over a display at positions conforming schematically to the positions of their respective corresponding wheels on the said vehicle.

13. Apparatus as claimed in any preceding claim, having respective first and second indicators, each for indicating a tyre condition for the same wheel of the vehicle, the said first indicator being arranged, when the apparatus is in use, so that its indication of tyre condition is perceivable in a driver/passenger compartment of the vehicle, and the second indicator being arranged, when the apparatus is in use, so that its indication of tyre condition is perceivable externally of the vehicle in the vicinity of said wheel; and
the said indicator control means being connected with each of the said first and second indicators and being operable, in dependence upon the said information relating to tyre condition, to change one or both indicators between said first, second and third states.

14. Apparatus as claimed in claim 13, wherein said first indicator is a visual indicator and said second indicator is an audio indicator.

15. Apparatus as claimed in claim 13 or 14, wherein the said indicator control means are operable to set both the first and second indicators into the same one of the said first, second and third states.

16. Apparatus as claimed in any one of claims 13 to 15, wherein the said first indicator is arranged at or in the vicinity of a dashboard of the vehicle when the apparatus is in use.

17. Apparatus as claimed in any one of claims 13 to 16, having:
a first module comprising said first indicator and first indicator activation means for activating said first indicator;
a second module comprising second indicator activation means for activating said second indicator and remote control means, connected operatively to said first indicator activation means, for supplying a remote control signal to said first indicator activation means to bring about activation of the said first indicator.

18. Apparatus as claimed in claim 17, having a connection wire, connecting said first module to said second module, through which power is supplied to said first module from said second module when the apparatus is in use;
wherein:
said remote control means are operable to supply said remote control signal by changing a power supply voltage applied by said second module to said first module via said connection wire; and
said first indicator activation means are operable to detect such a change in power supply voltage and to activate the said first indicator in response to such detection.

19. A vehicle as claimed in claim 18, wherein:
the said remote control means are operable to change the applied power supply voltage between respective first and second different values; and
the said first indicator activation means are operable to activate the said first indicator upon detecting that the said power supply voltage has the said first value.

20. Apparatus as claimed in claim 18 or 19, further comprising:
a tyre condition detector connected to said connection wire and operable to bring about a change in a signal carried by the connection wire in dependence upon a tyre condition of the said wheel;
said indicator control means being connected to the said connection wire and being operable to detect such a change in the said signal and to select one of said first, second and third states in dependence upon the detected change.

21. Apparatus as claimed in claim 20, wherein the said signal change is a change in current flowing through the said connection wire.

22. Apparatus as claimed in claim 20 or 21, wherein the said tyre condition detector brings about such signal changes at a frequency dependent upon the said tyre condition, and the said indicator control means are operable to detect the frequency of such signal changes and to select one of said first, second and third states in dependence upon the detected frequency.

23. Apparatus as claimed in claim 20, 21 or 22, wherein said tyre condition detector forms part of a further module, separate from said first and second modules.

24. Apparatus as claimed in any one of claims 20 to 23, wherein the said tyre condition detector is supplied continuously with operating power from the said second module via the said connection wire.

25. Apparatus as claimed in any one of claims 20 to 24, further comprising:
a brake pad wear detector operable to make an electrical connection between said connection wire and a source of predetermined potential when a brake pad of a vehicle wheel is in a worn condition;
said second module being further operable to detect when the said electrical connection is made by the said brake pad wear detector and to produce an indication of brake pad wear in response to such detection.

26. Apparatus as claimed in claim 25, wherein the said second module includes current limiting means connected for limiting the power supplied by the said second module when the said electrical connection is made by the said brake pad wear detector.

27. A vehicle including tyre condition indicating apparatus as claimed in any preceding claim.
